(19) United States
(12) Patent Application Publication
(10) Pub. No.: US 2006/0104476 A1
(43) Pub. Date: May 18, 2006

(54) Method for Authenticating the Compressed Image Data

(76) Inventor: Chao-Ho Chen, Tai-Nan City (TW)

Correspondence Address: NORTH AMERICA INTELLECTUAL PROPERTY CORPORATION, P.O. BOX 506, MERRIFIELD, VA, 22116, US

(21) Appl. No.: 11/163,507

(22) Filed: Oct. 20, 2005

(30) Foreign Application Priority Data
Nov. 16, 2004 (TW) 093135061

(51) Int. Cl. G06K 9/00

(52) U.S. Cl. 382/100

(57) ABSTRACT

Compressing image data includes partitioning original image data into non-overlapping blocks, transforming the non-overlapping blocks into Discrete Cosine Transform (DCT) coefficient blocks, and quantizing the DCT coefficient blocks to generate the quantized DCT blocks. A block-classification strategy is used to classify DCT-blocks into the flat-block and the normal-block. The quantized DCT blocks are then embedded with watermarks. And the watermarks are checked to determine whether the image data is tampered. Thus, the damaging problem of clipping errors caused by normailization in spatial domain can be reduced significantly.

### BACKGROUND OF THE INVENTION

1. Field of the Invention

The present invention relates to a method for authenticating the compressed image data, and more specifically, to a method of watermarking for authenticating the compressed image data by embedding watermarks.

2. Description of the Prior Art

In recent years, more and more applications for tamper detection of image data have been proposed because the applications can be used in the court to detect tampered images or to prove the image data have not been tampered. With the rapid growth of digital image data processing techniques, image data could be maliciously tampered while transferring through network or storing into a database, and they could be embezzled maliciously and illegally. Generally speaking, image data compression is used to decrease the data size to ease its transfer or storage. However, the image data could be damaged by the compression, therefore image data compression needs to be considered as one kind of legal image attack.

The prior art techniques for image data authentication are not very reliable, and there are two common types of authentication errors caused by the prior art techniques. The first type, false negative (missed detection), is the missed detection of tampered area in the tampered image, and we must detect it to guarantee the preciseness of authentication. It means that some actual detecting tampered areas in the tampered image will be likely missed. The second type, false positive (false alarm), is an incidental modification like the JPEG compression is a kind of “attack” that we would like to bypass. If an incidental attack is detected, it will cause a false positive type error. Therefore, it is important to judge whether the tampered image is resulted from the intentional action or the compression process.

### SUMMARY OF THE INVENTION

It is therefore an objective of the present invention to provide a compressed-image authentication method to solve the above problems.

The method of watermarking for authenticating the compressed image data comprises partitioning original image data into non-overlapping blocks, transforming the non-overlapping blocks into Discrete Cosine Transform (DCT) coefficient blocks, and quantizing the DCT coefficient blocks to generate quantized DCT blocks. When a quantized DCT block is a flat block, a watermark is embedded into a coefficient of the quantized DCT block.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart illustrating a method for compressing original image data of the present invention.

FIG. 2 is a diagram for the probability of false positive by various authentication steps in the normal blocks.

FIG. 3 is a diagram for the probability of false negative in the tampered image by various authentication strengths in the normal blocks.

FIG. 4 is a diagram of a source 8-by-8 pixel block.

FIG. 5 is a diagram of a quantized DCT block from FIG. 4.

FIG. 6 is a diagram of normal block watermarking for FIG. 5.

FIG. 7 is a diagram of a watermarked pixel block from FIG. 6.

FIG. 8 is a diagram of a zigzag order of the 8-by-8 pixel blocks.

### DETAILED DESCRIPTION

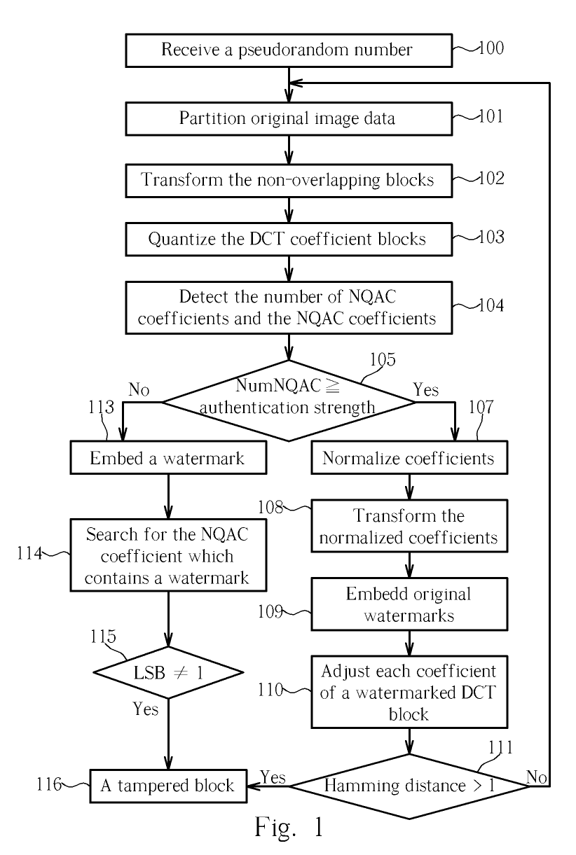

Please refer to FIG. 1, which is a flow chart illustrating a method for compressing original image data of the present invention. The method comprises following steps but not limited to the following sequence.

Step 100: receiving a fast one-dimensional pseudorandom number;

Step 101: partitioning original image data into 8-by-8 non-overlapping blocks. The original image data is part of a complete image. Each non-overlapping block has 8-by-8 pixels or coefficients. If the complete image has 384-by-288 pixels or coefficients, the complete image can be divided into 27 original image data since (384*288)/[(8*8)*(8*8)]=27 or 1728 non-overlapping blocks since (384*288)/(8*8)=1728;

Step 102: transforming the non-overlapping blocks into 8-by-8 DCT coefficient blocks by performing Discrete Cosine Transformation (DCT) according to a JPEG lossy compression standard;

Step 103: quantizing the DCT coefficient blocks to generate quantized DCT blocks according to a JPEG lossy compression standard;

Step 104: detecting number of non-zero quantized AC (NQAC) coefficients and the NQAC coefficients for each quantized DCT block;

Step 105: checking if the number of NQAC coefficients of the quantized DCT block is greater than or equal to an authentication strength which is 6 in the present embodiment; if so, the quantized block is regarded as a normal block, and the process continue in step 107 for watermarking the normal block; if not, the quantized block is regarded as a flat block, and the process continue in step 113 for watermarking the flat block;

Step 107: normalizing coefficients of the quantized DCT block from between 0 and 255 in a spatial domain to between 5 and 250 to generate a normalized DCT block. The normalization is used to reduce clipping errors of Y components of the gray-level image. If a normal block contains pixels with coefficients of extreme values such as between 0 to 5 and 250 to 255, and the normal block undergoes a transformation in step 108, the transformation will reduce the capability of the normal block to preserve watermarks which will be embedded in step 109. Therefore, the normalization is performed to eliminate the extreme values;

Step 108: transforming the normalized coefficients of the normalized DCT block to generate a transformed DCT block. The transformation is an iteration procedure which comprises dequantization, Inverse Discrete Cosine Transform (IDCT), normalization, Discrete Cosine Transform (DCT), and quantization. This iteration procedure will enable the coefficients of the normalized DCT block to remain the same throughout the transformation;

Step 109: embedding original watermarks to LSBs of some of the transformed coefficients of the transformed DCT block determined by an authentication step with an authentication strength by performing a backward zigzag scan to generate a watermarked DCT block. The transformed coefficients embedded with watermarks are part of the coefficients generated from the NQAC coefficients detected in step 104;

Step 110: adjusting each coefficient of the watermarked DCT block according to a corresponding transformed coefficient and a corresponding normalized coefficient;

Step 111: detecting if a hamming distance between a watermark of an adjusted coefficient and a corresponding original watermark is within a predetermined value; if not, go to step 116;

Step 113: embedding a watermark into an LSB of an NQAC coefficient of the quantized DCT block according to the fast one-dimensional pseudorandom number;

Step 114: searching the quantized DCT block for the NQAC coefficient which contains a watermark;

Step 115: detecting if the LSB of the NQAC coefficient equals to 1; if not, go to step 116; and

Step 116: affirming the quantized DCT block is tampered.

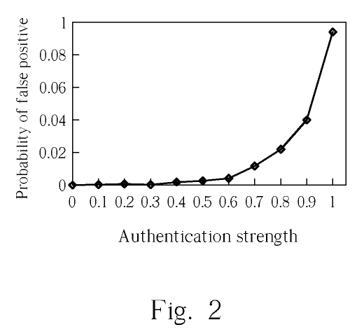

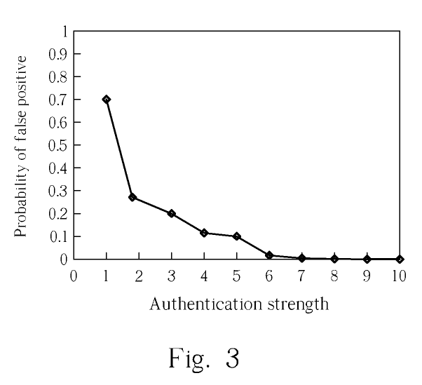

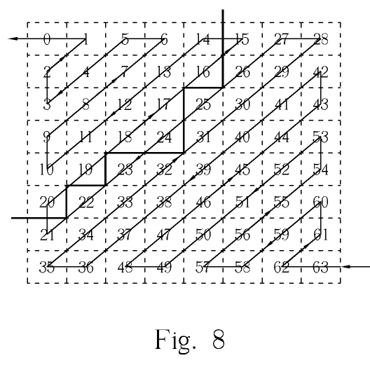

In Step 109, the number of transformed coefficients of the transformed DCT block to be embedded with watermarks is determined according to the following formula:
(NumNQAC−authentication strength)*authentication step (1)

wherein NumNQAC denotes the number of NQAC coefficients determined in step 104; an authentication step is a value between 0 and 1 and is specific to each transformed block; and the authentication strength is a reference number of transformed coefficients of a transformed DCT block to be embedded with watermarks. According to experiment results, the false positive, which is an incidental modification like the JPEG compression is a kind of “attack” that we would like to bypass of the color image. In other words, the degree of false positive of the color image will be decided by a reasonable trade-off choosing strategy of the authentication step; moreover, the larger authentication step results in higher quality of watermarked image. It's not suitable to embed obviously watermarks into the transformed coefficients in the higher frequency domain due to the effect of a quantization table of the JPEG lossy compression. However, while we embed watermarks into the transformed coefficients in the lower frequency domain, the watermarked coefficients will be easily changed due to the energy of image is more concentrated in the low frequency. Therefore, it is also not suitable to embed the watermark into the transformed coefficients in the low frequency domain. The probability of false positive can be calculated by the authentication step. For example, 8*8 blocks of source 352*288 image=1584 blocks since (352*288)/(8*8)=1584. If the authentication step is equal to “0.7” and the number of blocks of false positive in the image is 12, the probability of false positive will be calculated as (blocks of false positive)/(blocks of source image)=12/1584≈0.0075. According to our experimental results in the present embodiment, the probability of false positive will be almost zero when the value of the authentication step is under 0.5 and grow rapidly when the value of the authentication step is over 0.5, and the relationship between the probability of false positive and the authentication step will be illustrated and explained in FIG. 2. Therefore the optimal authentication step is “0.5” since it provides the best trade-off between the probability of false positive and the quality of watermarked image. In the present embodiment, we will reduce the false negative, which is the missed detection of tampered area in the tampered image, of image authentication by applying the authentication strength on the normal block. Regarding statistical experiments, we calculate the probability of false negative in the tampered image by the authentication strength. The probability becomes smaller with the rising of the authentication strength, and the relationship between the probability and the authentication strength will be illustrated and explained in FIG. 3. The value 6 of the authentication strength is applied for the proposed watermarking approach due to the best trade-off strategy, which is found in our experimental results of an embodiment of the present invention, between the probability of false negative and the quality of watermarked image. The backward zigzag order of scanning transformed coefficients of the transformed DCT block for generating a watermarked DCT block will be discussed in FIG. 8.

In Step 110, each coefficient of the watermarked DCT block is adjusted according to a corresponding coefficient and a corresponding coefficient of the watermarked DCT block. The formula of adjusting the coefficient, especially for the NQAC coefficient, of the watermarked DCT block, can be expressed as

$${NQAC}_{i}^{′} = \{ \begin{matrix}sign ( {NQAC}_{i} ) * {NQAC}_{i} , & if {Bit}_{0} ( \vert {NQAC}_{i} \vert ) = {w}_{i} \\ sign ( {NQAC}_{i} ) * AF ( {NQAC}_{i} ) , & if {Bit}_{0} ( \vert {NQAC}_{i} \vert ) \neq {w}_{i}\end{matrix} \qquad ( 2 )$$

wherein an NQAC′ coefficient is the adjusted value of the NQAC coefficient of the adjusted DCT block, an NQAC′ᵢ coefficient is the value of the NQAC′ coefficient belonging to the i-th adjusted DCT block of the 8-by-8 adjusted DCT blocks, wᵢ is a watermark bit to be embedded into the i-th adjusted DCT block of the 8-by-8 adjusted DCT blocks, and AF is an adjustment function that adjusts the value of NQAC′ᵢ. The 8-by-8 adjusted DCT blocks is assigned with various and unique serial numbers, which are in zigzag scan order of the adjusted DCT blocks, of between 0 and 63 so that the i-th adjusted DCT block of the 8-by-8 adjusted DCT blocks is the block with serial number i. The zigzag order of the 8-by-8 adjusted DCT blocks will be illustrated in FIG. 8.

The value of sign (NQACᵢ) is +1 or −1 and depends on the sign of NQACᵢ. The adjustment function AF has two features. The first feature, the NQACᵢ “1” will be altered into “0” while wᵢ is “0”. This will generate an extracting fault of the embedded watermark bit due to the absence of the watermarked NQAC. The second feature is to transform the NQACᵢ “2” or “−2” into “1” or “−1” while wᵢ is “1”. The definition of the adjustment function AF is as follows:

$$AF ( {NQAC}_{i} ) ⇒ \{ \begin{matrix}{Bit}_{0} ( \vert {NQAC}_{i} \vert ) = {w}_{i} & \\ {Bit}_{1} ( \vert {NQAC}_{i} \vert ) = {w}_{i} ⊕ 1 , & if \vert {NQAC}_{i} \vert = 1 \\ {Bit}_{1} ( \vert {NQAC}_{i} \vert ) = {w}_{i} ⊕ 1 , & if \vert {NQAC}_{i} \vert = 2\end{matrix} \qquad ( 3 )$$

wherein ⊕ denotes an XOR operation. For example, according to the results of the normal block watermarking, the NQACᵢ “1” is “1”, “−2” is “−1”, “3” is “3”, “−4” is “−5” while wᵢ is “1”. The other NQACᵢ “1” is “2”, “−2” is “−2”, “3” is “2”, “4” is “4” while wᵢ is “0”.

Step 111 is performed for all of the watermarks of the adjusted DCT block in step 110. When a hamming distance between a watermark of an adjusted coefficient and a corresponding original watermark is beyond the predetermined value, even if all other hamming distances are within the predetermined value for the same watermarked DCT block, step 116 will still affirm that the quantized DCT block is tampered.

In Step 113, a watermark is embedded into a Least Significant Bit (LSB) of a coefficient of the quantized DCT block. According to the characteristic of the few embedding capability in flat blocks, fewer watermarks are embedded into flat blocks than into normal blocks. Based on the robust of image authentication, we can find out the coefficients which can be safely embedded with watermarks by statistics. We count the existence probability of each NQAC coefficient by statistics for the flat blocks. Consequently, the absent positions of Quantized AC (QAC) coefficients, where the existence probability of NQAC is zero, are the safe watermarked points. Positions of the safe watermarked points with better quality are concentrated in middle-frequency region of the flat block according to frequency domain appearing in DCT of the JPEG lossy compression. We pick out four fixed watermarked points whose locations are (2, 6), (3,5), (5,3), and (6,1) in the 8-by-8 coefficient flat block and embed only one watermark bit into one of them, wherein the locations of the points in the northwest corner and the southeast corner of the 8-by-8 coefficient flat block are (1,1) and (8,8). To consider the security of image authentication, we use the fast one-dimensional pseudorandom number received in Step 100 to choose positions to be embedded by watermark bit “1”. We embed the watermark bit “1” into the LSB bit of the chosen i-th Quantized AC coefficient QACᵢ in each flat block. The QACᵢ will be altered to QACᵢ′ as
Bit₀(QACᵢ′)=Bit₀(QACᵢ)⊕1, i=2*pₖ₊₁+pₖ (4)

wherein the value of i is between 0 and 3, the value of k is between the value of 0 and length of the fast one-dimensional pseudorandom number p, pₖ and pₖ₊₁ are the (k+1)-th and k-th bits of p, and the possible chosen locations of QACᵢ in the 8-by-8 coefficient flat block can be represented as QACᵢ{0≦i≦3}={(2,6),(3,5),(5,3),(6,1)}. For the better trade-off between the robust of image authentication and the quality of watermarked image, we can replace the pseudorandom number p with the last bit Bit₀ and the first bit Bit₁ of the quantized DC coefficient in each flat blocks. We have three watermark bits comprising Bit₀, Bit₁ of the pseudorandom number p and the embedded watermark bit to authenticate the tampered blocks in the flat blocks. It is very useful for the robust of image authentication and maintaining the quality of watermarked image.

In Step 114, the quantized DCT block is searched for the coefficient that contains a watermark. The previous fast one-dimensional pseudorandom number p in Step 113 is used to find out the watermarked coefficient by extracting the (k+1)th bit pₖ₊₁ and the kth bit pₖ of the pseudorandom number p.

In Step 116, the quantized DCT block is considered as a tampered block, and the blocks which are not tampered are authenticated blocks.

Please refer to FIG. 2, which is a diagram for the probability of false positive vs. authentication steps in the normal blocks. According to FIG. 2, the probability of false positive will be almost zero when the value of the authentication step is under 0.5 and grow rapidly when the value of the authentication step is over 0.5. A higher probability of false positive corresponds to a lower quality of watermarked image. And a higher authentication step corresponds to a higher quality of watermarked image. Therefore the optimal choice for the authentication step is “0.5” since it has the highest authentication step for all near zero probability of false positive.

Please refer to FIG. 3, which is a diagram for the probability of false negative in the tampered image vs. authentication strengths in the normal blocks. According to FIG. 3, the probability becomes smaller with the rising of the authentication strength. A higher probability of false negative corresponds to a lower quality of watermarked image. And a lower authentication strength corresponds to a higher quality of watermarked image. Therefore the optimal choice for the authentication strength is “6” since it has the lowest authentication strength for all near zero probability of false negative.

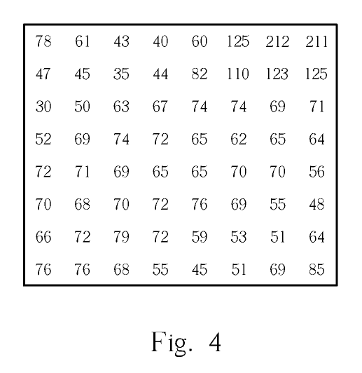

Please refer to FIG. 4, which is a diagram of an 8-by-8 non-overlapping block (corresponding to step 101). Each coefficient corresponds to the luminance of a corresponding pixel.

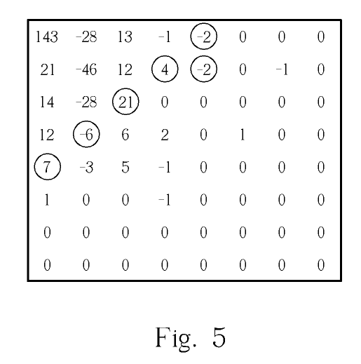

Please refer to FIG. 5, which is a diagram of a transformed DCT block generated from FIG. 4 (corresponding to step 108). When the authentication step equals 0.5, the chosen NQAC coefficients are {−2, −2, 4, 21, −6, 7}.

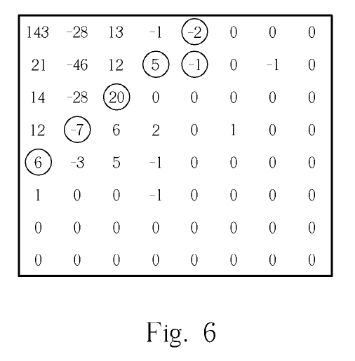

Please refer to FIG. 6, which is a diagram of a watermarked DCT block generated from FIG. 5 (corresponding to step 109). After watermarking the transformed DCT block, the NQAC coefficients become {−1, −2, 5, 20, −7, 6}.

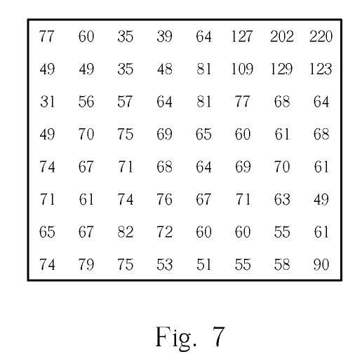

Please refer to FIG. 7, which is a diagram of an adjusted DCT block generated from FIG. 6 (corresponding to step 110). As shown in FIGS. 4 and 7, the adjusted coefficients in FIG. 7 are very close to the coefficients in FIG. 4. If the adjusted DCT block is determined as not tampered, the adjusted DCT block will be received as the restored non-overlapping block.

Please refer to FIG. 8, which illustrates a zigzag sequence of the 8-by-8 transformed DCT blocks. All of the coefficients of the transformed DCT block are assigned with serial numbers between 0 and 63. The coefficients with serial numbers 10, 11, 12, 13, 14, 16 are selected for watermarking by performing a backward zigzag scan. In FIG. 8, watermarks can only be embedded into the coefficients in the left-upper portion because that portion is not of high frequencies.

It is an advantage of the present invention that semi-fragile watermarking has excellent strength and sensitivity against tampering of image data, therefore semi-fragile watermarking is able to measure the degree of tampering of image data and distinguish malicious tampering of image data from legal image attacks.

Therefore, the present invention can detect whether the image is tampered maliciously or tampered by image compression. The present invention can also decrease the probability of misjudging illegal tampering (i.e. false positive) and authentication (i.e. false negative).

What is claimed is:

1. A method of watermarking for authenticating compressed image data comprising following steps:
(a) partitioning original image data into non-overlapping blocks;
(b) transforming the non-overlapping blocks into Discrete Cosine Transform (DCT) coefficient blocks;
(c) quantizing the DCT coefficient blocks to generate quantized DCT blocks; and
(d) when a quantized DCT block is a flat block, embedding a watermark into a coefficient of the quantized DCT block.

2. The method of claim 1 wherein step (a) is partitioning original image data into 8-by-8 non-overlapping blocks.

3. The method of claim 1 wherein step (b) is transforming the non-overlapping blocks into 8-by-8 Discrete Cosine Transform (DCT) coefficient blocks.

4. The method of claim 1 wherein steps (b) and (c) are performed according to a JPEG lossy compression standard.

5. The method of claim 1 further comprising detecting number of non-zero quantized AC (NQAC) coefficients and the NQAC coefficients of each quantized DCT block.

6. The method of claim 5 further comprising checking if the number of NQAC coefficients of the quantized DCT block is greater than or equal to an authentication strength.

7. The method of claim 5 further comprising receiving a pseudorandom number wherein step (d) comprises embedding a watermark into a least significant bit of an NQAC coefficient of the quantized DCT block determined by the pseudorandom number.

8. The method of claim 7 further comprising following steps:
(e) searching the quantized DCT block for the NQAC coefficient which contains the watermark; and
(f) detecting whether the quantized DCT block is tampered according to the NQAC coefficient.

9. The method of claim 8 wherein step (f) comprises detecting if the least significant bit (LSB) of the NQAC coefficient equals to a predetermined number.

10. The method of claim 9 wherein step (f) comprises detecting if the least significant bit (LSB) of the NQAC coefficient equals to 1.

11. The method of claim 6 further comprising step (e): when a quantized DCT block is a normal block, eliminating clipping errors of the quantized DCT block.

12. The method of claim 11 wherein step (e) comprises normalizing coefficients of the quantized DCT block in step (e).

13. The method of claim 12 wherein step (e) further comprises transforming the normalized coefficients of the quantized DCT block to generate a transformed DCT block.

14. The method of claim 13 further comprising step (f): embedding original watermarks into the coefficients of the transformed DCT block.

15. The method of claim 14 wherein step (f) comprises embedding original watermarks to least significant bits of coefficients of the transformed DCT block determined by an authentication step with an authentication strength by performing a backward zigzag scan for generating a watermarked DCT block.

16. The method of claim 14 wherein step (e) further comprises adjusting a coefficient of the watermarked DCT block according to a corresponding transformed coefficient and a corresponding normalized coefficient.

17. The method of claim 16 further comprising detecting if a hamming distance between a watermark of an adjusted coefficient and a corresponding original watermark is within a predetermined value.

18. A method for authenticating compressed image data comprising:
(a) searching a quantized DCT block for a coefficient which contains a watermark;
(b) detecting whether the quantized DCT block is tampered according to the coefficient.

19. The method of claim 18 wherein step (b) comprises detecting if a least significant bit (LSB) of the coefficient equals to a predetermined number.

20. The method of claim 19 wherein step (b) comprises detecting if a least significant bit (LSB) of the coefficient equals to 1.

21. A method of watermarking for authenticating compressed image data comprising:
(a) partitioning original image data into non-overlapping blocks;
(b) transforming the non-overlapping blocks into Discrete Cosine Transform (DCT) coefficient blocks;
(c) quantizing the DCT coefficient blocks to generate quantized DCT blocks;
(d) when a quantized DCT block is a normal block, embedding watermarks into the quantized DCT block.

22. The method of claim 21 wherein step (a) is partitioning original image data into 8-by-8 non-overlapping blocks.

23. The method of claim 21 wherein step (b) is transforming the non-overlapping blocks into 8-by-8 Discrete Cosine Transform (DCT) coefficient blocks.

24. The method of claim 21 wherein steps (b) and (c) are performed according to a JPEG lossy compression standard.

25. The method of claim 21 further comprising detecting number of non-zero quantized AC (NQAC) coefficients and the NQAC coefficients of each quantized DCT block.

26. The method of claim 25 further comprising checking if the number of NQAC coefficients of the quantized DCT block is greater than an authentication strength.

27. The method of claim 26 further comprising step (e): when a quantized DCT block is a normal block, eliminating clipping errors of the quantized DCT block.

28. The method of claim 27 wherein step (e) comprises normalizing coefficients of the quantized DCT block in step (e).

29. The method of claim 28 wherein step (e) comprises normalizing coefficients of the quantized DCT block from between 0 and 255 to between 5 and 250.

30. The method of claim 28 wherein step (e) further comprises transforming the normalized coefficients of the quantized DCT block to generate a transformed DCT block.

31. The method of claim 30 further comprising step (f): embedding original watermarks into the transformed DCT block.

32. The method of claim 31 wherein step (f) comprises embedding original watermarks to least significant bits of coefficients of the transformed DCT block determined by an authentication step with an authentication strength by performing a backward zigzag scan for generating a watermarked DCT block.

33. The method of claim 31 wherein step (e) further comprises adjusting a coefficient of the watermarked DCT block according a corresponding transformed coefficient and a corresponding normalized coefficient.

34. The method of claim 33 further comprising detecting if a hamming distance between a watermark of an adjusted coefficient and a corresponding original watermark is within a predetermined value.
